(19) United States
(12) Patent Application Publication
(10) Pub. No.: US 2010/0215425 A1
(43) Pub. Date: Aug. 26, 2010

(54) INNER TOP CORNER CONNECTOR OF CONTAINER BODY

(75) Inventors: T.H. HUANG, Qingdao (CN); Robert WANG, Qingdao (CN); Ryan XU, Qingdao (CN); Jack ZHANG, Qingdao (CN)

Correspondence Address: Workman Nydegger;1000 Eagle Gate Tower, 60 East South Temple, Salt Lake City, UT, 84111, US

(73) Assignees: CHINA INTERNATIONAL MARINE CONTAINERS (GROUP) LTD., Shenzhen (CN); QINGDAO CIMC REEFER TRAILER CO., LTD., Qingdao (CN); QINGDAO CIMC REEFER CONTAINER MANUFACTURE CO., LTD., Qingdao (CN); QINGDAO CIMC SPECIAL REEFER CO., LTD., Qingdao (CN)

(21) Appl. No.: 12/705,041

(22) Filed: Feb. 12, 2010

(30) Foreign Application Priority Data
Feb. 20, 2009 (CN) 200920009962.8

(51) Int. Cl. B61D 17/12; B62D 27/02

(52) U.S. Cl. 403/24; 105/409; 52/45; 296/191

(57) ABSTRACT

An inner top corner connector of a container body which comprises an angled fitting made of elastic ABS or PVC material and having an angle of 95°-105°, an inner roof sheet connecting portion of the angled fitting is provided with an outer seal blade inclining upward near an end thereof at an outer side thereof. An inner side panel connecting portion of the angled fitting is provided with a connecting plate for connecting a top end of the inner side panel of the container body. The connecting plate is provided with a guide blade. An inserting groove is jointly formed by the guide blade, the inner side panel connecting portion and a part of the connecting plate. The inner roof sheet connecting portion and the inner side panel connecting portion have warping portions directing outward at ends thereof, respectively.

### CROSS REFERENCE TO RELATED APPLICATIONS

The present application claims a priority to Chinese patent application No. 200920009962.8 filed on Feb. 20, 2009, which is herein incorporated by reference in entirety thereof.

### FIELD OF THE INVENTION

The present invention relates to an inner top corner connector for an inner roof sheet and an inner side panel of a thermal container body.

### BACKGROUND OF THE INVENTION

A container body of a van, a van trailer or a freight container in refrigerated, thermal or dry cargo type consists of an inner plate, an outer plate, and a foaming heat preservation layer between the inner plate and the outer plate, in which the inner plate comprises an inner side panel, an inner roof sheet, and an aluminum floor. Since there is a large quantity of water vapor in the refrigerated container body, connections between adjacent components should have a good sealing property. In a usual case, the inner side panel is connected to the inner roof sheet via an angle aluminum which is drawn out through a profile and acts as a connector, the angle aluminum is connected to the inner side panel and the inner roof sheet respectively via blind rivets. However, since there is a gap at the rivets, and even an rivet mandrel has not good sealing property, it is easy for the water vapor in the container body to invade into the heat preservation layer via the gap at the rivets or the rivet mandrel, which reduces the heat preservation effect of the heat preservation layer. In addition, in this traditional connecting manner, the connector is connected to the inner side panel and the inner roof sheet in a mechanical and hard manner. Thereby, during uploading cargo into the container body or downloading cargo out of the container body, the angle aluminum may deform as a roof bow deforms, which would yield a repeated shearing action among the inner side panel, the inner roof sheet, the angle aluminum, and the rivets; with the time elapses, the angle aluminum would loose and the sealing property would further lower, and thus the water vapor in the container body would easily invade into the heat preservation layer and consequently further lower the heat preservation effect. Moreover, for connecting the inner side panel and the inner roof sheet via the angle aluminum, it is usual to install the angle aluminum inside the container body after a general assembly of the container body is finished, and it may require a special clamping tools to fix the angle aluminum and take a large quantity of labor to complete the installation of the rivets, causing waste of time and labor.

### BRIEF SUMMARY OF THE INVENTION

An object of the present invention is to provide an inner top corner connector of a container body capable of improving heat preservation effect of the container body with respect to the above deficiencies in the prior art.

In order to attain the above object, the following technical solutions may be adopted according to the present invention.

According to the present invention, an inner top corner connector of a container body comprises an angled fitting made of elastic ABS or PVC material and having an angle of 95°-105°; an inner roof sheet connecting portion of the angled fitting for connecting an inner roof sheet of the container body is provided with an outer seal blade, which inclines upward and directs toward the end of the inner top roof sheet connecting portion, near an end of the inner top roof sheet connecting portion at an outer side of the inner top roof sheet connecting portion; an inner side panel connecting portion of the angled fitting for connecting an inner side panel of the container body is provided with a connecting plate for connecting a top end of the inner side panel of the container body; the connecting plate is provided with a guide blade at a portion of the connecting plate closing to the inner side panel connecting portion; an inserting groove for receiving the top end of the inner side panel is jointly formed by the guide blade, the inner side panel connecting portion and a part of the connecting plate; the inner roof sheet connecting portion and the inner side panel connecting portion have warping portions directing outward at ends thereof, respectively.

The inner roof sheet connecting portion of the angled fitting is provided with an inner seal blade, which inclines upward and directs toward a bent position of the angled fitting, near the bent position at the outer side of the inner top roof sheet connecting portion.

The guide blade is provided with a warping portion, which departs from the inner side panel connecting portion, at a lower part of the guide blade.

The angle of the angled fitting is 100°.

The advantages and the positive effects according to the inner top corner connector of the container body of the present invention are as follows. In the inner top corner connector of the present invention, since the two seal faces of the inner top corner connector for connecting the inner roof sheet and the inner side panel do not have a right angle but a angle of 95°-105°, the inner top corner connector of elastic ABS or PVC material may have a very large compress amount when the roof sheet of the container body presses down This may not only eliminate the dimension tolerance produced in the manufacturing process but also primarily enable the connector and the inner roof sheet to attain compressing seal, and consequently the container body has good sealing effect. Moreover, the sealing effect of the container body may be further improved due to the outer seal blade provided on the inner roof sheet connecting portion of the connector and the inserting groove provided at the inner side panel connection portion for receiving the inner side panel. A pressure between the connector and the inner roof sheet may achieve an optimum state through an inner top corner connector which has an appropriate strength produced from a setting hardness of ABS or PVC material with calculation. During the application of the present invention, since rivets are installed only at the inner side panel connecting portion of the container body, the number of rivets used is relative small, and no leakage-out occurs, which may effectively prevent water vapor in the container body from invading into the heat preservation layer via a rivet hole and the mandrel portion of the blind rivet and thus maintain good heat preservation property of the container body. In addition, the connection between the inner top corner connector and the inner side panel and the inner roof sheet is not of a mechanical type, but an elastic type. When the container body is subject to a force and thereby bends, the connector may have large displacement with respect to the inner roof sheet and the inner side panel by means of the characteristics itself, and the connector may restore into an original seal state after the deformation restores. That is to say, the inner top corner connector of the present invention has large degree of freedom and may restore after deformation, and thus good sealing property may be assured for a long time. The heat preservation property of the container body is directly determined by the sealing property, and thus a container body may have good heat preservation property with using the inner top corner connector of the present invention.

The above and other objects, features and advantages will be more apparent by way of the following description of preferred embodiments with reference to the drawings.

### BRIEF DESCRIPTION OF THE DRAWING

FIG. 1 is a structural diagram of an inner top corner connector of a container body according to the present invention;

FIG. 2 is a structural diagram illustrating that an inner roof sheet and an inner side panel of a container body are connected through the inner top corner connector of the container body according to the present invention; and

FIG. 3 is a diagram illustrating that a strengthening wood mass in the side panel of the container body is fixed on a strengthening rib of the side panel of the container body via a tapping screw.

### DETAILED DESCRIPTION OF THE INVENTION

Hereinafter, embodiments of the present invention will be described in details. It should be noted that the embodiments as set forth herein is only used for illustration, but not limiting the present invention.

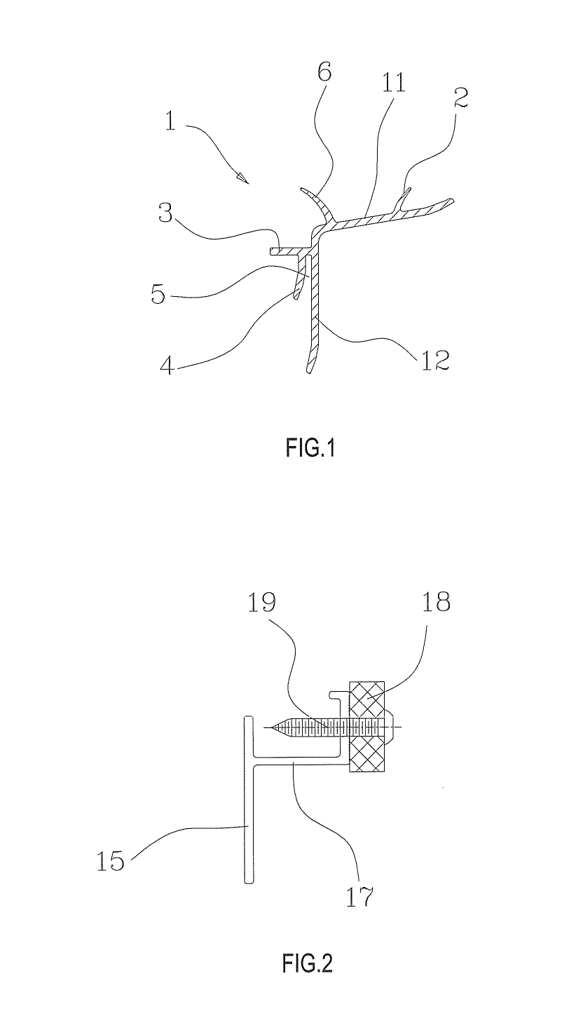

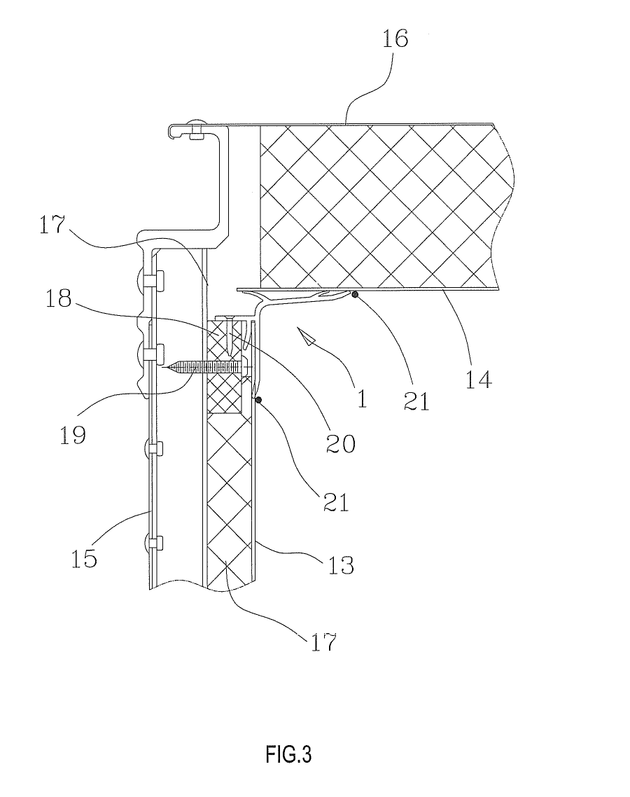

As shown in FIG. 2 and FIG. 3, a container body of a van, a van trailer and a freight container in refrigerated, thermal or dry cargo type consists of an inner plate, an outer plate, and a foaming heat preservation layer between the inner plate and the outer plate. The inner plate comprises an inner side panel 13, an inner roof sheet 14, and an aluminum floor (not illustrated in the figures). The outer plate comprises an outer side panel 15, an outer roof sheet 16 and so on. A strengthening rib 17 with a L-shape cross section is connected onto the outer side panel 15.

As shown in FIG. 1, an inner top corner connector according to the present invention comprises an angled fitting 1 made of elastic ABS material or engineering plastic material. The angled fitting 1 may be also made of other elastic material, such as PVC, etc. One part of the angled fitting 1 is an inner roof sheet connecting portion 11 for connecting the inner roof sheet 14, and the other part of the angled fitting 1 is an inner side panel connecting portion 12 for connecting an inner side panel 13. An angle between these two portions is 100°, but not limited to 100°. The angle is feasible within a range of 95°-105°. The inner roof sheet connecting portion 11 of the angled fitting 1 is provided with an outer seal blade 2, which directs toward an end of the inner roof sheet connecting portion 11, near the end thereof at an outer side thereof (i.e. a side directing toward the inner roof sheet during installation). The outer seal blade 2 may function as good sealing so as to prevent water vapor in the container body from permeating into the foaming heat preservation layer of the roof sheet. The inner roof sheet connecting portion 11 of the angled fitting 1 is provided with an inner seal blade 6, which inclines upward and directs toward a bent position of the angled fitting 1, near the bent position at the outer side thereof. A function of the inner seal blade 6 is to obstruct the foaming material in the foaming heat preservation layer from overflowing and prevent foam from leaking. The inner side panel connecting plate 12 of the angled fitting 1 is provided with a connecting plate 3, which is horizontal and integral with the inner side panel connecting plate 12, on a side directing toward the inner side panel 21 The connecting plate 3 is for connecting a top end of the inner side panel of the container body. The connecting plate 3 is provided with a guide blade 4, which is almost in parallel with the inner side panel connecting portion 12, at a portion of the connecting plate 3 near the inner side panel connecting portion 12. An inserting groove 5 for receiving the top end of the inner side panel 13 is jointly formed by the guide blade 4, the inner side panel connecting portion 12 and a part of the connecting plate 3. The guide blade 4 is provided with a warping portion, which departs from the inner side panel connecting portion 12, at a lower part of the guide blade 4; the guide blade 4 with the warping portion may allow the inner side panel 13 to be easily inserted into the inserting groove 5. The inner roof sheet portion 11 and the inner side panel connecting portion 12 of the angled fitting 1 have warping portion directing outward at ends thereof, respectively, and these two warping portions may make two ends of the inner top corner connector of the container body of the present invention sufficiently contact with the inner roof sheet 14 and the inner side panel 13, which is beneficial to improve the sealing property of the container body.

As shown in FIG. 2 and FIG. 3, the connection of the inner roof sheet and the inner side panel of the container body through the inner top corner connector of the container body of the present invention is achieved through the following steps: fixing strengthening wood mass 18 on side panel strengthening ribs 17 through tapping screws 18 in advance, so that each strengthening rib 17 is fixed with a piece of the strengthening wood mass 18; beginning to install the inner top corner connector of the present invention just after the foaming material in the heat preservation layer of the side panel has foamed; applying a sealant inside the inserting groove 5 of the inner top corner connector and inserting the inserting groove 5 onto the top end of the inner side panel 13; adjusting the orientation of the inner top corner connector, and fixing the connecting plate 3 onto respective strengthening wood mass 18 via a number of steel nails 20; during the general assembly, slowly lowering the roof sheet, observing the situation of the inner top corner connector when the inner roof sheet 14 contacts with the inner top corner connector 1, at the same time lightly knocking the inner top corner connector 1 so as to assure that the inner top corner connector sufficiently contacts with the inner roof sheet 14 and completely seals; after fixing the roof sheet and completing secondary foaming, applying a sealant 21 respectively at end portions where the inner top corner connector 1 respectively contacts with the inner side panel 13 and the inner roof sheet 14. In the present invention, there exists a dual-sealing between a vertical side of the inner top corner connector and the inner side panel 13, in which one sealing is from the sealant 21 and the other sealing is from the inserting groove 5 and the sealant inside the inserting groove 5; there exists a tri-sealing between the inner roof sheet connecting portion 11 of the inner top corner connector and the inner roof sheet 14, in which the first sealing is from a sealant 21, the second sealing is from the outer seal blade 2, and the third sealing is from the inner seal blade 6. Therefore, the container body has good sealing property with the inner top corner connector of the present invention.

The inner side panel connecting portion 12 of the inner top corner connector of the present invention is fixedly connected to the side panel via the steel nails 20, and self-press of the inner roof sheet connecting portion 11 completely depends on the shape and material property of the inner top corner connector and the weight of the roof sheet, which requires very low precision control during installation and is convenient to install. The two sealing faces of the inner top corner connector does not have a right angle, but 95°-105°, and thus when the roof sheet is pressed down, the inner top corner connector of elastic ABS material may have a very large compression amount. This may not only eliminate the dimension tolerance produced in the manufacturing process but also enable the connector and the roof sheet to realize a compressing seal. Since the inner top corner connector is made of the elastic ABS material, the hardness of the ABS material may be adjusted during manufacture of the inner top corner connector, so as to make a pressure between the connector and the inner roof sheet 14 reach an optimum state.

After the inner top corner connector of the present invention is connected to the inner side panel 13 and the inner roof sheet 14, no rivet is exposed on the whole external surface. At the same time, the connector of the present invention may be arbitrarily matched with the color of an inner wall of the container body, so as to attain an effect that the connector may be integral with the inner wall of the container and consequently has a good appearance.

Due to the inner top corner connector of the present invention, the number of fastener may be reduced by half, and no special device and special clamping tools are required, so the process is simple, convenient and quick. At the same time, installation limitation is relative loose; cost, labor and time are effectively saved, the efficiency is improved It may be convenient to install and use the connector of the present invention in factory or other places.

The present invention is suitable to the connection between the inner roof sheet and the inner side panel of the container body of a van, a van trailer or a semi-trailer carrier in refrigerated, thermal or dry cargo type, or a refrigerated, or thermal freight container.

Although the present invention has been described with reference to the several typical embodiments, it should be understood that the terminology used herein is descriptive and illustrative, but not limitative. Since the present invention may be embodied in various forms without departing from the spirit or essentiality of the present invention, it should be understood that the above embodiments are not limited to any previous details and should be widely interpreted within the range of the spirit and the scope defined by the attached claims of the present invention, therefore all changes and variants falling within the claims and the equivalent scope thereof would be covered by the attached claims.

What is claimed is:

1. An inner top corner connector of a container body, comprising:
an angled fitting made of elastic ABS or PVC material and having an angle of 95°-105°, comprising:
an inner roof sheet connecting portion for connecting an inner roof sheet of the container body, having a warping portion directing outward at an end of the inner roof sheet connecting portion;
an outer seal blade provided near an end of the inner roof sheet connecting portion at an outer side of the inner roof sheet connecting portion, and inclining upward and directing toward the end of the inner roof sheet connecting portion;
an inner side panel connecting portion for connecting an inner side panel of the container body, having a warping portion directing outward at an end of the inner side panel connecting portion;
the connecting plate for connecting a top end of the inner side panel of the container body, provided on the inner side panel connecting portion;
a guide blade provided at a portion of the connecting plate closing to the inner side panel connecting portion; and
an inserting groove for receiving the top end of the inner side panel, jointly formed by the guide blade, the inner side panel connecting portion and a part of the connecting plate.

2. The inner top corner connector of the container body according to claim 1, further comprising:
an inner seal blade provided near a bent position of the angled fitting at the outer side of the inner roof sheet connecting portion, and inclining upward and directing toward the bent position.

3. The inner top corner connector of the container body according to claim 1, wherein the guide blade is provided with a warping portion, which departs from the inner side panel connecting portion, at a lower part of the guide blade.

4. The inner top corner connector of the container body according to claim 2, wherein the guide blade is provided with a warping portion, which departs from the inner side panel connecting portion, at a lower part of the guide blade.

5. The inner top corner connector of the container body according to claim 3, wherein the angle of the angled fitting is 100°.

6. The inner top corner connector of the container body according to claim 4, wherein the angle of the angled fitting is 100°.
